(19) United States
(12) Patent Application Publication
(10) Pub. No.: US 2018/0101052 A1
(43) Pub. Date: Apr. 12, 2018

(54) DISPLAY MODULE, MANUFACTURING METHOD THEREOF, AND CORRESPONDING DISPLAY DEVICE

(71) Applicant: BOE TECHNOLOGY GROUP CO., LTD., Beijing (CN)

(72) Inventors: Yafeng YANG, Beijing (CN); Jing LV, Beijing (CN)

(21) Appl. No.: 15/545,338

(22) PCT Filed: Jan. 6, 2017
(86) PCT No.: PCT/CN17/70367

§ 371 Date: Jul. 21, 2017

(30) Foreign Application Priority Data
Apr. 8, 2016 (CN) 201610217279.8

(51) Int. Cl. G02F 1/1335

(52) U.S. Cl. CPC G02F 1/133514; G02F 1/133609; G02F 2001/134354; G02F 1/133603; G02F 1/133606

(57) ABSTRACT

A display module, a manufacturing method thereof and a corresponding display device are disclosed. The display module includes a pixel unit at least having a first subpixel, a second subpixel and a third subpixel. The display module further includes at least one prism structure arranged on a light incident side of the pixel unit. After incident light passes through the prism structure, the incident light is at least split into light of a first waveband incident on the first subpixel, light of a second waveband incident on the second subpixel and light of a third waveband incident on the third subpixel, wherein the first waveband, the second waveband and the third waveband are different from each other.

The present application is the U.S. national phase entry of PCT/CN2017/070367, with an international filling date of Jan. 6, 2017, which claims the benefit of Chinese patent application No. 201610217279.8 filed on Apr. 8, 2016, the entire disclosures of which are incorporated herein by reference.

### FIELD

This disclosure relates to the field of display technologies, and in particular to a display module, a manufacturing method thereof and a corresponding display device.

### BACKGROUND ART

As a flat display device, the liquid crystal display device is increasingly applied to various display fields, for example, in products or components having a display function such as televisions, cellphones and computers. As shown in FIG. 1, a liquid crystal display device comprises a backlight source 100, an array substrate 101 and a color filter substrate 109 aligned with each other, as well as liquid crystal molecules 103 arranged between the array substrate 101 and the color filter substrate 109. After passing through the liquid crystal molecules with different deflection angles, light rays emitted from the backlight source 100 can display different grayscales, and then achieve color display through a color filtering effect by the color filter substrate 109. Specifically, a color filter layer composed of a red color filter sub-unit (R), a green color filter sub-unit (G) and a blue color filter sub-unit (B) is arranged on the color filter substrate 109.

However, in the above display device, the backlight source 100 emits white light as a mixture of red light, green light and blue light. After the white light passes through the red color filter sub-unit (R), only the red light is transmitted while the blue light and the green light are absorbed. In a similar way, after the white light passes through the green color filter sub-unit (G), only the green light is transmitted while the red light and the blue light are absorbed. Likewise, after the white light passes through the blue color filter sub-unit (B), only the blue light is transmitted while the red light and the green light are absorbed. As a result, about two thirds of the light rays are directly absorbed by the color filter layer, which reduces transmittance of light emitted from the backlight source 100 after passing through the color filter layer.

### SUMMARY

Embodiments of this disclosure provide a display module, a manufacturing method and a corresponding display device, in order to improve transmittance of backlight by a display device equipped with the display module.

According to a first aspect of this disclosure, a display module is provided. The display module comprises a pixel unit at least comprising a first subpixel, a second subpixel and a third subpixel. The display module further comprises at least one prism structure arranged on a light incident side of the pixel unit. The prism structure is configured such that after passing through the prism structure, incident light is at least split into light of a first waveband incident on the first subpixel, light of a second waveband incident on the second subpixel and light of a third waveband incident on the third subpixel, wherein the first waveband, the second waveband and the third waveband are different from each other.

In certain exemplary embodiments, the display module further comprises a color filter unit arranged on a light exit side of the prism structure. The color filter unit at least comprises a first subunit, a second subunit and a third subunit. Specifically, the first subunit corresponds to the first subpixel, the second subunit corresponds to the second subpixel and the third subunit corresponds to the third subpixel.

In certain exemplary embodiments, the pixel unit further comprises a fourth subpixel. The prism structure is further configured such that after passing through the prism structure, the incident light is split into light of a first waveband, light of a second waveband, light of a third waveband and light of a fourth waveband. The light of the fourth waveband is incident on the fourth subpixel. Furthermore, the light of the first waveband is red light, the light of the second waveband is green light, the light of the third waveband is blue light, and the light of the fourth waveband is any one of yellow light, cyan light and magenta light.

In certain exemplary embodiments, the prism structure is a triangular prism structure. Specifically, a refractive index of the prism structure matches with that of an array substrate on which the pixel unit is arranged. Moreover, an angle is enclosed between a first side surface at the light incident side of the prism structure and an incident direction of the incident light. In this case, the first side surface is a curved surface protruding away from the pixel unit. Besides, a second side surface at the light exit side of the prism structure is a planar surface in parallel to the array substrate.

In certain exemplary embodiments, the prism structure is a triangular prism structure. Specifically, a first side surface at the light incident side of the prism structure is planar, and an angle is enclosed between the first side surface and an incident direction of the incident light. Besides, a second side surface at the light exit side of the prism structure is a curved surface protruding towards the pixel unit.

In certain exemplary embodiments, a radius of curvature of the curved surface mentioned above is 100 μm-800 μm.

In certain exemplary embodiments, the angle enclosed between the first side surface mentioned above and the incident direction of the incident light crosses over the first side surface and gradually increases from 15° to 75°.

In certain exemplary embodiments, the angle enclosed between the first side surface mentioned above and the incident direction of the incident light falls within a range of 15°-75°.

In certain exemplary embodiments, the prism structure comprises a plurality of strip-shaped prism structures, each strip-shaped prism structure corresponding to a column of pixel units in position.

In certain exemplary embodiments, the prism structure comprises a plurality of block-shaped prism structures, each block-shaped prism structure corresponding to a pixel unit in position.

Further in certain exemplary embodiments, the display module comprises a lower polarizer, and the prism structure is arranged on a light incident side of the lower polarizer.

According to a second aspect of this disclosure, a display device is further provided. The display device comprises: any of display modules as mentioned above, and a backlight source for emitting parallel light.

According to a third aspect of this disclosure, a manufacturing method of a display module is further provided. The manufacturing method specifically comprises: forming a pixel unit on a base substrate, the pixel unit at least comprising a first subpixel, a second subpixel and a third subpixel. The manufacturing method further comprises: forming at least one prism structure on a light incident side of the pixel unit by an imprinting process or a patterning process. The prism structure is configured such that after passing through the prism structure, incident light is at least split into light of a first waveband incident on the first subpixel, light of a second waveband incident on the second subpixel and light of a third waveband incident on the third subpixel. Specifically, the first waveband, the second waveband and the third waveband are different from each other.

Embodiments of this disclosure provide a display module, a manufacturing method thereof and a corresponding display device. The display module comprises a pixel unit comprising a first subpixel, a second subpixel and a third subpixel. The display module further comprises at least one prism structure arranged on a light incident side of the pixel unit. The prism structure is configured such that after passing through the prism structure, incident light is at least split into light of a first waveband incident on the first subpixel, light of a second waveband incident on the second subpixel and light of a third waveband incident on the third subpixel, wherein the first waveband, the second waveband and the third waveband are different from each other.

In case the display module is applied to a display device having a backlight source, since the white light emitted from the backlight source is a mixture of light having different wavelengths, the prism structure in the display module can at least split the light with different wavelengths into light of a first waveband, light of a second waveband and light of a third waveband under an effect of refraction. Based on that, after splitting, the light of the first waveband, the light of the second waveband and the light of the third waveband can be further converged by the prism structure and incident on the first subpixel, the second subpixel and the third subpixel respectively. In this way, the light of the first waveband is fully transmitted through the first subpixel, the light of the second waveband is fully transmitted through the second subpixel, and the light of the third waveband is fully transmitted through the third subpixel. That is to say, with the prism structure mentioned above, light rays emitted from the backlight source can be at least split into light rays of three wavebands. Further, light rays of the three wavebands can be converged onto corresponding subpixels by the prism structure, and all transmitted through the subpixels respectively, which improves transmittance of light rays emitted from the backlight source.

### BRIEF DESCRIPTION OF DRAWINGS

In order to illustrate technical solutions in embodiments of this disclosure more clearly, drawings to be used in depicting the embodiments will be briefly introduced as follows. Apparently, the drawings in the depiction below are only some embodiments of this disclosure. For those having ordinary skills in the art, other embodiments can be further obtained from these drawings without any further inventive efforts.

FIG. 1 is a schematic structure view of a typical liquid crystal display device;

FIG. 2a is a schematic structure view of a display module and backlight source according to an embodiment of this disclosure;

FIG. 2b is a schematic structure view of another display module and backlight source according to an embodiment of this disclosure;

FIG. 3a is a schematic view of a prism structure according to an embodiment of this disclosure;

FIG. 3b is a schematic view for a light splitting process by a prism structure according to an embodiment of this disclosure;

FIG. 3c is a schematic view for a light splitting process by another prism structure according to an embodiment of this disclosure;

FIG. 3d is a schematic view for a light splitting process by yet another prism structure according to an embodiment of this disclosure;

FIG. 3e is a schematic view for a light splitting process by still another prism structure according to an embodiment of this disclosure;

FIG. 3f is a schematic view for a light splitting process by a further prism structure according to an embodiment of this disclosure;

FIG. 4 is a schematic view showing calculation of a height and a width of the prism structure in FIG. 3b;

FIG. 5a is a schematic view of a strip-shaped prism structure according to an embodiment of this disclosure;

FIG. 5b is a schematic view of a block-shaped prism structure according to an embodiment of this disclosure; and

FIG. 6 is a manufacturing method of a display module according to an embodiment of this disclosure.

### DETAILED DESCRIPTION OF EMBODIMENTS

Technical solutions in embodiments of the present disclosure shall be described clearly and completely as follows with reference to the drawings. Apparently, the embodiments described below are only part of embodiments of this disclosure, rather than all of them. Based on the embodiments in this disclosure, all other embodiments obtainable by a person having ordinary skills in the art without making inventive efforts shall fall within the protection scope of this disclosure.

In the depiction below, various components used in embodiments of this disclosure are indicated by the following reference signs. Specifically, 01—display module; 100—backlight source; 101—array substrate; 102—counter substrate; 103—liquid crystal molecule; 104—pixel unit; 1041—first subpixel; 1042—second subpixel; 1043—third subpixel; 105—color filter unit; 1051—first subunit; 1052—second subunit; 1053—third subunit; 106—prism structure; 1061—first side surface; 1062—second side surface; 107—lower polarizer; 108—non-display region; 109—color filter substrate; 200—incident light; 201—light of first waveband; 202—light of second waveband; and 203—light of third waveband.

Moreover, it should be pointed out that light transmission views shown in the drawings are only exemplary, but do not represent any limitations to this disclosure. Such light transmission views are only provided to help interpretation of the basic principle of this disclosure, and those skilled in the art benefiting from this disclosure can easily conceive of other equivalent light transmissions.

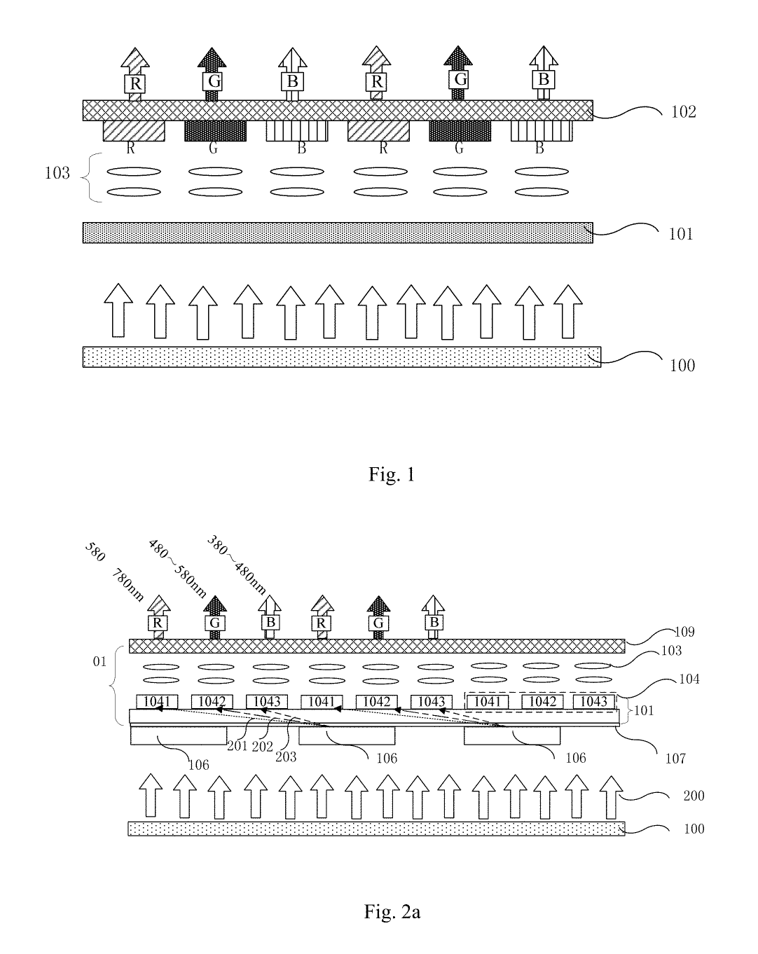

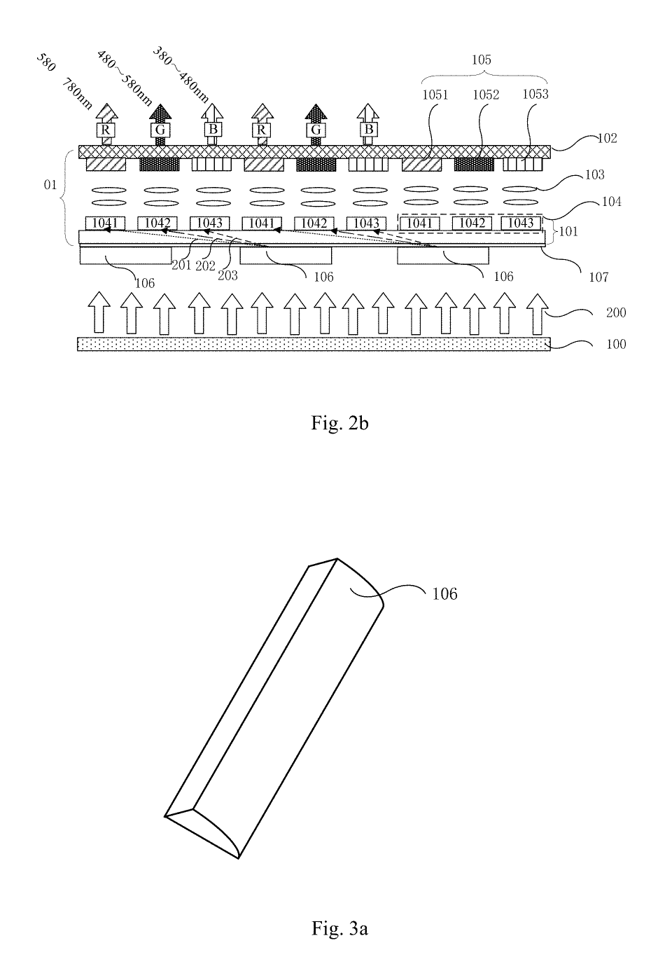

Embodiments of this disclosure provide a display module. As shown in FIG. 2a, the display module 01 can comprise a pixel unit 104. The pixel unit 104 can at least comprise a first subpixel 1041, a second subpixel 1042 and a third subpixel 1043. Furthermore, the display module 01 can comprise at least one prism structure 106 arranged on a light incident side of the pixel unit 104. Besides, the prism structure 106 can be configured such that after passing through the prism structure 106, incident light is at least split into light of a first waveband 201 incident on the first subpixel 1041, light of a second waveband 202 incident on the second subpixel 1042 and light of a third waveband 203 incident on the third subpixel 1043. Specifically, the first waveband, the second waveband and the third waveband can be different from each other.

It should be noted that as shown in FIG. 2a, the display module 01 can usually comprise an array substrate 101 and a counter substrate 102 aligned with each other.

In this case, passing through the light incident side of the pixel unit 104 means that when the display module 01 is applied to a display device having a backlight source 100, the backlight source 100 is usually arranged on a side of the array substrate 101 facing away from the counter substrate 102, i.e., on a light incident side of the pixel unit 104.

Besides, the pixel unit 104 can be arranged on the array substrate 101. Specifically, the pixel unit 104 usually comprises a plurality of subpixels. The subpixels are defined by gate lines and data lines crossing transversally and longitudinally on the array substrate 101.

Based on that, when the number of subpixels comprised in the pixel unit 104 varies, the number of wavebands into which the incident light 200 is split after passing through the prism structure 106 also varies.

For example, when the pixel unit 104 comprises a first subpixel 1041, a second subpixel 1042 and a third subpixel 1043, the incident light 200 can be split into light of a first waveband 201, light of a second waveband 202 and light of a third waveband 203 after passing through the prism structure 106. Furthermore, the first subpixel 1041, the second subpixel 1042 and the third subpixel 1043 can be divided into red (R), green (G) and blue (B) subpixels respectively.

Generally, white light emitted from the backlight source 100 usually has a wavelength of 380 nm-780 nm. Based on that, the prism structure 106 can split white light into light of a first waveband 201 having a wavelength of 580 nm-780 nm, light of a second waveband 202 having a wavelength of 480 nm-580 nm and light of a third waveband 203 having a wavelength of 380 nm-480 nm. In this case, the light of the first waveband 201 can be fully transmitted through the first subpixel 1041, the light of the second waveband 202 can be fully transmitted through the second subpixel 1042, and the light of the third waveband 203 can be fully transmitted through the third subpixel 1043.

Obviously, the explanations provided above are only given exemplarily when the first subpixel 1041, the second subpixel 1042 and the third subpixel 1043 are red (R), green (G) and blue (B) subpixels respectively. Besides, the first subpixel 1041, the second subpixel 1042 and the third subpixel 1043 can be cyan, magenta and yellow respectively. Division of specific wavebands will not be detailed here for simplicity.

As another example, when the pixel unit 104 comprises a first subpixel 1041, a second subpixel 1042, a third subpixel 1043 and a fourth subpixel, the incident light 200 can be split into light of a first waveband 201, light of a second waveband 202, light of a third waveband 203 and light of a fourth waveband after passing through the prism structure 106. Specifically, the first subpixel 1041, the second subpixel 1042 and the third subpixel 1043 can be red (R), green (G) and blue (B) subpixels respectively. The fourth subpixel can be any one of yellow, cyan and magenta subpixels.

In this case, the fourth subpixel is chosen for example as yellow. The prism structure 106 can split white light into light of a first waveband 201 having a wavelength of 600 nm-780 nm, light of a second waveband 202 having a wavelength of 470 nm-570 nm, light of a third waveband 203 having a wavelength of 380 nm-470 nm, and light of a fourth waveband having a wavelength of 570 nm-600 nm. In this way, the light of the first waveband 201 can be fully transmitted through the first subpixel 1041, the light of the second waveband 202 can be fully transmitted through the second subpixel 1042, the light of the third waveband 203 can be fully transmitted through the third subpixel 1043, and the light of the fourth waveband 204 can be fully transmitted through the fourth subpixel.

It should be noted that the first, second, third and fourth wavebands only indicate the number of wavebands into which the incident light 200 can be split after passing through the prism, but do not specifically represent certain fixed wavebands. For example, the light of the second waveband 202 can have a wavelength falling between 480 nm-580 nm, or between 470 nm-570 nm as divided upon needs.

Embodiments of this disclosure provide a display module. The display module comprises a pixel unit which at least comprises a first subpixel, a second subpixel and a third subpixel. The display module further comprises at least one prism structure arranged on a light incident side of the pixel unit. The prism structure can be configured such that after passing through the prism structure, incident light is at least split into light of a first waveband incident on the first subpixel, light of a second waveband incident on the second subpixel and light of a third waveband incident on the third subpixel. Specifically, the first waveband, the second waveband and the third waveband can be different from each other.

When the display module is applied to a display device having a backlight source, since the white light emitted from the backlight source is a mixture of light having different wavelengths, the prism structure in the display module can at least split the light with different wavelengths into light of a first waveband, light of a second waveband and light of a third waveband under an effect of refraction. Based on that, after splitting, the light of the first waveband, the light of the second waveband and the light of the third waveband can be further converged by the prism structure and incident on the first subpixel, the second subpixel and the third subpixel respectively. In this case, the light of the first waveband can be fully transmitted through the first subpixel, the light of the second waveband be fully transmitted through the second subpixel, and the light of the third waveband be fully transmitted through the third subpixel. That is to say, with the prism structure, light rays emitted from the backlight source can be at least split into light rays of three wavebands. Further, light rays of the three wavebands can be converged onto corresponding subpixels by the prism structure and all transmitted therethrough respectively, which improves transmittance of light rays emitted from the backlight source.

In view of the above, the display module 01 can further comprise a color filter unit 105 arranged on a light exit side of the prism structure 106, in order to improve purity of light transmitted through the pixel unit 104. Specifically, as shown in FIG. 2b, the color filter unit 105 can be manufactured on the counter substrate 102 to form a color filter substrate 109.

Specifically, when the pixel unit 104 comprises at least a first subpixel 1041, a second subpixel 1042 and a third subpixel 1043, the color filter unit 105 at least comprises a first subunit 1051, a second subunit 1052 and a third subunit 1053. Specifically, the first subunit 1051 corresponds to the first subpixel 1041, the second subunit 1052 corresponds to the second subpixel 1042, and the third subunit 1053 corresponds to the third subpixel 1043.

In this case, after passing through the prism structure 106, white light emitted from the backlight source 100 can be split into: red light of a first waveband 201 having a wavelength of 580 nm-780 nm; green light of a second waveband 202 having a wavelength of 480 nm-580 nm; and blue light of a third waveband 203 having a wavelength of 380 nm-480 nm. In order to improve purity of monochromatic light emitted from the display module 01, the wavebands of light transmittable through the subunits can be further reduced.

For example, light transmittable through the first subunit 1051 can have a wavelength of 600 nm-780 nm (smaller than the light of first waveband 201). Thus, light ways having a wavelength of 580 nm-600 nm in the light of first waveband 201 will be filtered by the first subunit 1051.

Likewise, light transmittable through the second subunit 1052 can have a wavelength of 480 nm-570 nm (smaller than the light of second waveband 202), and light transmittable through the third subunit 1053 can have a wavelength of 370 nm-470 nm (smaller than the light of third waveband 203). In this way, when the red, green and blue light are all transmitted through the corresponding subpixel units, the first subunit 1051, the second subunit 1052 and the third subunit 1053 can further filter the red light, the green light and the blue light respectively, so as to improve purity of the monochromatic light.

It should be noted that the first subunit 1051 can be made of a red resin material, the second subunit 1052 can be made of a green resin material, and the third subunit 1053 can be made of a blue resin material, in order that the first subunit 1051, the second subunit 1052 and the third subunit 1053 can further filter the red light, the green light and the blue light respectively.

In addition, if the number of subpixels comprised in the pixel unit 104 increases, the number of subunits in the color filter unit 105 increases accordingly. For example, if the pixel unit 104 further comprises the fourth subpixel, the color filter unit 105 can comprise a fourth subunit corresponding to the fourth subpixel.

Specific structures of the prism structure 106 will be explained exemplarily as follows.

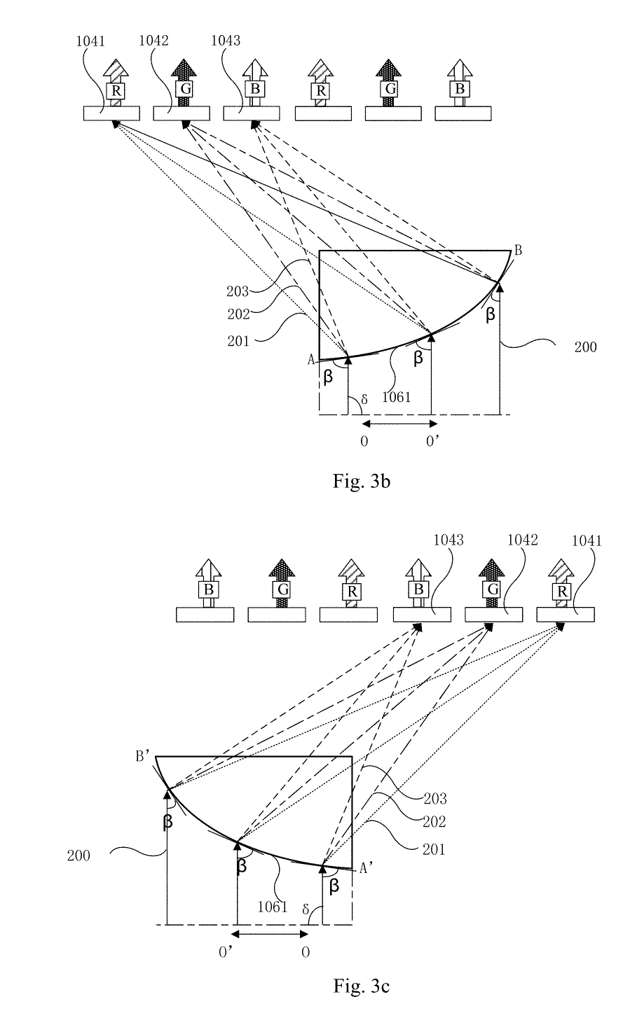

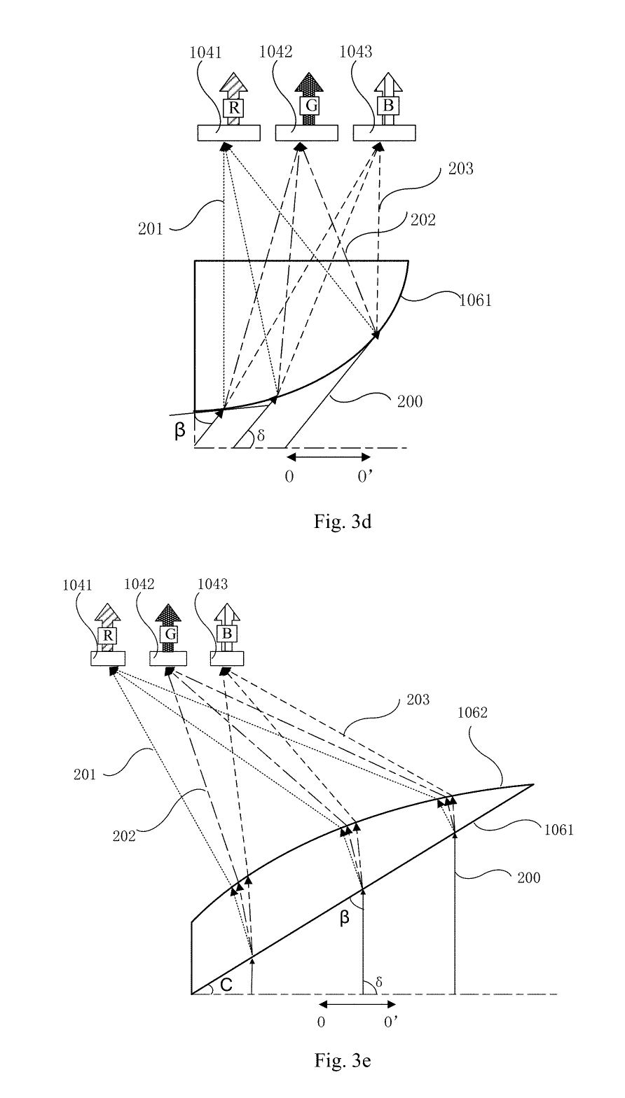

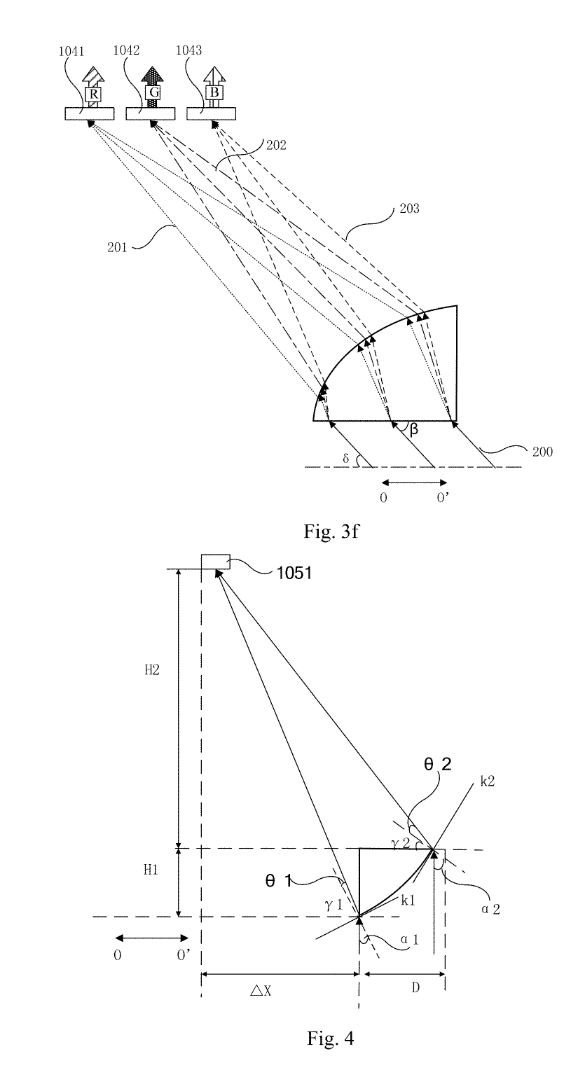

For example, as shown in FIG. 3a, the prism structure 106 can be a triangular prism structure. Specifically, as shown in FIG. 3b or 3c, an angle β is enclosed between a first side surface 1061 at the light incident side of the prism structure 106 and an incident direction of the incident light 200. The first side surface 1061 is globoidal, specifically, a curved surface protruding away from the pixel unit. In this way, the first side surface 1061 of the prism structure 106 can split the incident light 200 into light of a first waveband 201, light of a second waveband 202 and light of a third waveband 203, and then converge the light of the first waveband 201, the light of the second waveband 202 and the light of the third waveband 203 onto the first subunit 1051, the second subunit 1052 and the third subunit 1053 respectively.

Generally, in order to improve the utilization of light, the incident light 200 of the backlight source 100 is preferably parallel light. In this case, when only an angle δ enclosed between the incident light 200 and a direction (O-O′) where a display plane is located changes, light exit directions for light of the first waveband 201, light of the second waveband 202 and light of the third waveband 203 split by the prism structure 106 will also change. Specifically, the array substrate 101 and the counter substrate 102 are both parallel to the direction (O-O′) where the display plane is located.

Specifically, as shown in FIG. 3b, when the backlight source 100 is a collimated light source, the incident light 200 can be incident perpendicularly with respect to the direction (O-O′) where the display plane is located. In this way, the incident light 200 is incident on the first side surface 1061 of the prism structure 106 with an angle β enclosed therebetween. Thereby, the incident light 200 on the first side surface 1061 is split into light of three different wavebands, namely light of the first waveband 201, light of the second waveband 202 and light of the third waveband 203. Meanwhile, the first side surface 1061 can be globoidal, specifically a curved surface protruding away from the pixel unit 104. Therefore, under an effect of the curved surface, light of the first waveband 201, light of the second waveband 202 and light of the third waveband 203 can be converged respectively onto the first subpixel 1041, the second subpixel 1042 and the third subpixel 1043 at upper left of the prism structure 106.

It should be noted that the angle β enclosed between the incident light 200 and the first side surface 1061 is associated with a tangential slope of the first side surface 1061 at an incident position of the incident light 200. The smaller the angle β is, the greater the tangential slope at the incident position is. However, when the angle β is zero, the incident light 200 cannot enter the first side surface 1061 of the prism structure 106. Moreover, when the angle β is 90°, the incident light 200 is perpendicularly incident on the first side surface 1061 of the prism structure 106, and hence still cannot be split. As can be seen, the angle β can fall from 0° to 90°. Therefore, in FIG. 3b, a tangent of an angle enclosed between the first side surface 1061 and the incident light should be greater than 0 and smaller than +∞. That is, the tangent of an angle enclosed between the first side surface 1061 and the incident light gradually increases from point A to point B, wherein the tangent of the angle at point A is greater than 0, and the tangent of the angle at point B is smaller than +00. In this case, after splitting, light of the first waveband 201, light of the second waveband 202 and light of the third waveband 203 will be projected onto the first subpixel 1041, the second subpixel 1042 and the third subpixel 1043 respectively at upper left of the prism structure 106.

Besides, as shown in FIG. 3c, an angle enclosed between the first side surface 1061 and the incident light can further fall between 0° and 90° on the other side. In this case, after splitting, light of the first waveband 201, light of the second waveband 202 and light of the third waveband 203 will also be projected onto the first subpixel 1041, the second subpixel 1042 and the third subpixel 1043 respectively at upper right of the prism structure 106.

Furthermore, in order to avoid a cost rise caused by a higher processing precision, an angle β enclosed between the first side surface 1061 of the prism structure 106 and the incident light can be optionally greater than or equal to 1°, and smaller than or equal to 89°. That is, an angle β enclosed between the first side surface 1061 and the incident light gradually increases from point A to point B, wherein the angle β at point A is greater than or equal to 1°, and the angle β at point B is smaller than or equal to 89°. Alternatively, an angle β enclosed between the first side surface 1061 and the incident light gradually increases from point A′ to point B′, wherein the angle β at point B′ is smaller than or equal to 89°, while the angle β at point A′ is greater than or equal to 1°.

Based on that, in order to further improve a diffusion effect of the prism structure 106, as shown in FIG. 3b, the angle β enclosed between the first side surface 1061 of the prism structure 106 and the incident light gradually increases from point A to point B, wherein the angle β at point A is greater than or equal to 15°, and the angle β at point B is smaller than or equal to 75°. Alternatively, as shown in FIG. 3c, the angle β enclosed between the first side surface 1061 of the prism structure 106 and the incident light gradually increases from point A′ to point B′, wherein the angle β at point B′ is smaller than or equal to 75°, while the angle β at point A′ is greater than or equal to 15°.

Moreover, directional terms such as “upper”, “lower”, “left” and “right” are all defined herein with respect to the schematic disposition of the display module in the drawings. However, it should be understood that these directional terms are relative concepts, and they are only used for descriptive and clarifying purposes, and thus can correspondingly vary with the direction in which the display module is disposed.

Alternatively, when the backlight source 100 is a parallel light source, as shown in FIG. 3d, the incident light 200 can be incident obliquely with respect to the direction (O-O′) where the display plane is located. In this way, with comparison to the solution of FIG. 3b in which the incident light 200 is perpendicular to the direction (O-O′) where the display plane is located, light exit directions of the light of the first waveband 201, the light of the second waveband 202 and the light of the third waveband 203 obtained from splitting of the incident light 200 by the prism structure 106 will be changed. For example, the light can be projected onto the first subpixel 1041, the second subpixel 1042 and the third subpixel 1043 respectively above the prism structure 106.

To sum up, a goal of changing light exit directions of the light of the first waveband 201, the light of the second waveband 202 and the light of the third waveband 203 can be achieved by only adjusting the angle δ enclosed between the incident light 200 and the direction (O-O′) where the display plane is located.

In another example, as shown in FIG. 3e, in the prism structure 106, the first side surface 1061 at the light incident side can be planar, and an angle β is enclosed between the first side surface 1061 and an incident direction of the incident light. Likewise, optionally, the angle β enclosed between the planar first side surface 1061 and the incident light can fall within a range of 15°-75°, in order to further enhance a diffusion effect of the prism structure 106. Based on that, a second side surface 1062 at the light exist side of the prism structure 106 can be globoidal, specifically a curved surface protruding towards the pixel unit 104. In this way, the first side surface 1061 of the prism structure 106 can split the incident light 200 into light of a first waveband 201, light of a second waveband 202 and light of a third waveband 203. Furthermore, the second side surface 1062 of the prism structure 106 will converge light of the first waveband 201, light of the second waveband 202 and light of the third waveband 203 onto the first subpixel 1041, the second subpixel 1042 and the third subpixel 1043 respectively.

As can be seen, after splitting, the light of the first waveband 201, the light of the second waveband 202 and the light of the third waveband 203 can be converged respectively by the globoidal first side surface 1061 shown in FIG. 3b (or 3d) and the globoidal second side surface 1062 shown in FIG. 3d. The smaller a radius of curvature of the curved surface is, the more highly the light of the first waveband 201, the light of the second waveband 202 and the light of the third waveband 203 will be converged. However, when the radius of curvature of the curved surface is greater than 3 mm, the curved surface approximates to a planar structure, which reduces a converging effect for the light of the first waveband 201, the light of the second waveband 202 or the light of the third waveband 203. Based on that, the radius of curvature of the curved surface can be optionally 100 μm-800 μm, in order to further improve a converging effect of the light.

Besides, as mentioned above, when only the angle δ enclosed between the incident light 200 and the direction (O-O′) where the display plane is located changes, light exit directions of the light of the first waveband 201, the light of the second waveband 202 and the light of the third waveband 203 split by the prism structure 106 will also change. However, when the angle δ enclosed between the incident light 200 and the direction (O-O′) where the display plane is located changes, it is also necessary to adjust a tilt angle between the first side surface 1061 of the prism structure 106 and the direction (O-O′) where the display plane is located, in order to ensure that light exit directions of the light of the first waveband 201, the light of the second waveband 202 and the light of the third waveband 203 split by the prism structure 106 are not changed.

Specifically, when the backlight source 100 is a collimated light source, as shown in FIG. 3e, the angle δ is 90°, such that the incident light 200 can be incident perpendicular with respect to the direction (O-O′) where the display plane is located. Meanwhile, an angle C is enclosed between the first side surface 1061 and the direction (O-O′) where the display plane is located, and the angle C is an acute angle. However, as shown in FIG. 3f, when the backlight source 100 is a parallel light source, an angle δ is enclosed between the incident light 200 and the direction (O-O′) where the display plane is located, and the angle δ is an acute angle, such that the incident light 200 can be incident obliquely. Meanwhile, the first side surface 1061 is parallel to the direction (O-O′) where the display plane is located. As can be known from FIGS. 3e and 3f, light exit directions of the light of the first waveband 201, the light of the second waveband 202 and the light of the third waveband 203 split by the prism structure 106 are the same, such that the light of the first waveband 201, the light of the second waveband 202 and the light of the third waveband 203 are incident respectively onto the first subpixel 1041, the second subpixel 1042 and the third subpixel 1043 at upper left of the prism structure 106. Since the first side surface 1061 is parallel to the direction (O-O′) where the display plane is located in FIG. 3f, an increase in a contact area between the first side surface 1061 and other components is facilitated. For example, when the prism structure 106 is attached over a thin film layer of the array substrate 101, the attaching effect between the prism structure 106 and the thin film layer can be improved, and probabilities for the prism structure 106 to fall off can be reduced.

It should be noted that in this disclosure, specific positions of the prism structure 106 in the display module 01 are not limited, and it can be manufactured on either the array substrate 101 or the counter substrate 102. Optionally, as shown in FIG. 2a or 2b, in case the display module 01 has a lower polarizer 107, the prism structure 106 can be arranged on a light incident side of the lower polarizer 107. This helps to avoid influences on the internal structure of a liquid crystal cell formed by the array substrate 101 and the counter substrate 102 when the prism structure 106 is manufactured on the array substrate 101 or the counter substrate 102.

In addition, when a preset position for the prism structure 106 in the display module 01 is determined, a thickness D and a width H1 of the prism structure 106 can be calculated based on an angle of a certain side surface of the prism structure 106 with respect to the incident light, so as to facilitate processing of the prism structure 106. Specifically, to take the prism structure 106 in FIG. 3b as an example, the incident light 200 is split into light of a first waveband 201 incident on the first subpixel 1041 after passing through the first side surface 1061 of the prism structure 106. Specifically, as shown in FIG. 4, the thickness D and the width H1 of the prism structure 106 can be derived from a slope of the first side surface 1061, an incident direction of the incident light 200 as well as positional relationships between the first subpixel 1041 for receiving the light of the first waveband 201 and the prism structure 106.

Specifically, the thickness D and the width H1 of the prism structure 106 are calculated through formula (1) and formula (2) by choosing the incident light 200 at point A where a slope for the first side surface 1061 of the prism structure 106 is minimum and at point B where the slope is maximum:

tan(θ1+γ1)=(H1+H2)/ΔX; (1)

tan(θ2+γ2)=H2/(ΔX+D); (2)

In the above formulas,

γ1 is equal to a coangle for an incident angle α1 of the incident light 200 at point A, i.e., γ1=π/2−α1; α1=arctank1; k1 is a tangential slope at point A, all of them being known;

γ2 is equal to a coangle for an incident angle α2 of the incident light 200 at point B, i.e., γ2=π/2−α2; α2=arctank2; k2 is a tangential slope at point B, all of them being known;

θ1 is a refraction angle for the incident light 200 after incident at point A, i.e., sin θ1=sin α1/n, and n is a refractive index of the prism structure 106;

θ2 is a refraction angle for the incident light 200 after incident at point B, i.e., sin θ2=sin α2/n;

ΔX is a distance between the prism structure 106 and the first subpixel 1041 for receiving the light of the first waveband 201 in a horizontal direction (along the direction O-O′), which can be set based on the preset position and is known; and

H2 is a distance between the prism structure 106 and the first subpixel 1041 for receiving the light of the first waveband 201 in a vertical direction (i.e. perpendicular to the direction O-O′), which can be set based on the preset position and is known.

To sum up, in both formula (1) and formula (2), θ1, θ2, γ1, γ2, ΔX and H2 are all known. Therefore, the thickness D and the width H1 of the prism structure 106 can be derived from a combination of formula (1) and formula (2). Thus, the prism structure 106 can be processed according to dimensions calculated above, and then mounted at the preset position in the display module. Obviously, when parameters of H1 and D are preset as knowns, H2 or ΔX can also be calculated through formula (1) and formula (2), which will not be limited here.

Furthermore, the array substrate 101 comprises pixel units 104 arranged in a matrix. The pixel unit 104 further comprises a first subpixel 1041, a second subpixel 1042 and a third subpixel 1043. Therefore, if each pixel unit 104 corresponds to a prism structure 106, light of the first waveband 201, light of the second waveband 202 and light of the third waveband 203 split by each prism structure 106 are all incident onto the first subpixel 1041, the second subpixel 1042 and the third subpixel 1043 respectively in each pixel unit 104. Accordingly, the incident light 200 can be diffused to a maximum degree and then converged on the pixel unit 104, which can further improve transmittance of the incident light 200 after passing through the pixel unit 104.

Specific structures of each pixel unit 104 corresponding to a prism structure 106 will be explained exemplarily as follows.

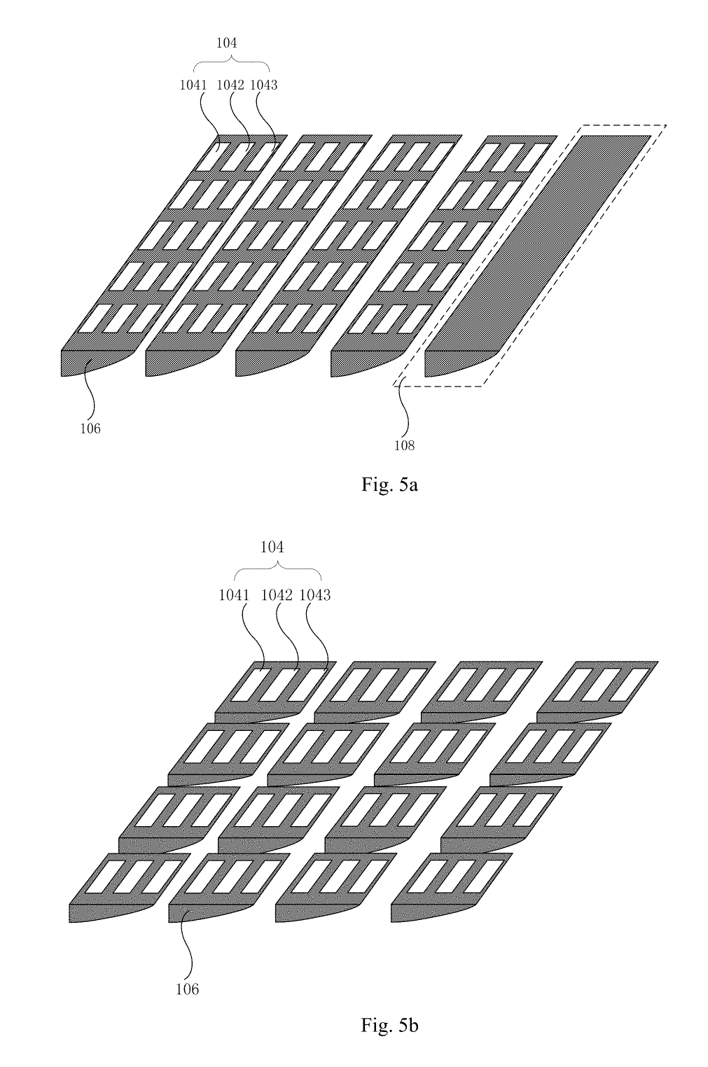

For example, as shown in FIG. 5a, the prism structure 106 can comprise a plurality of strip-shaped prism structures, each strip-shaped prism structure 106 corresponding to a column of pixel units 104 in position.

In another example, as shown in FIG. 5b, the prism structure 106 can also comprise a plurality of block-shaped prism structures, each block-shaped prism structure 106 corresponding to a pixel unit 104 in position.

It should be noted that that if the prism structure 106 as shown in FIG. 3b or 3f is adopted, the incident light 200 is split into light of a first waveband 201, light of a second waveband 202 and light of a third waveband 203 after passing through the prism structure 106 and then converged respectively on the first subpixel 1041, the second subpixel 1042 and the third subpixel 1043 at upper left of the prism structure 106. As a result, at least one last column of pixel units 104 in the array substrate 101 cannot receive the light split by the prism structure 106, which influences a display effect of the display module 01.

In order to deal with the above problem, as shown in FIG. 5a, at least one strip-shaped prism structure 106 or at least one column of block-shaped prism structures 106 can be further arranged in a non-display region 108 of the display module 01. This helps to ensure that at least one last column of pixel units 104 in the array substrate 101 can also receive the light of the first waveband 201, the light of the second waveband 202 and the light of the third waveband 203 split by each prism structure 106 arranged in the non-display region.

Embodiments of this disclosure further provide a display device. The display device can comprise any of display modules 01 mentioned above, and a backlight source 200 for emitting parallel light. Furthermore, the backlight source 200 can further be a collimated light source.

It should be noted that the prism structure 106 in the display device can also be mounted on a light exit side of the backlight source 200. However, as compared with a solution where the prism structure 106 is arranged on the light incident side of the lower polarizer 107, a certain gap is required between the backlight source 200 and the display module 01. This will lead to a considerable mounting error for the prism structure 106 mounted on the light exit side of the backlight source 200. In view of this, the prism structure 106 is preferably arranged on the light incident side of the lower polarizer 107 in this disclosure.

It should be noted that structures and beneficial effects of the display module in the display device are the same as those of the display module provided in any of above embodiments. As beneficial effects of the display module have been described in detail in the above embodiments, this will not be repeated here for simplicity.

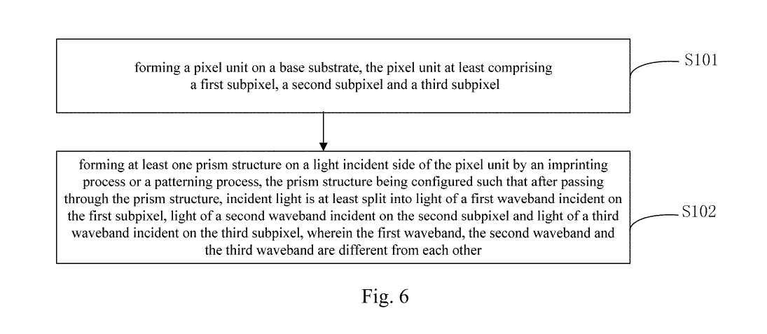

Embodiments of this disclosure further provide a manufacturing method of a display module. As shown in FIG. 6, the manufacturing method can comprise: step S101, forming a pixel unit 104 on a base substrate, the pixel unit 104 at least comprising a first subpixel 1041, a second subpixel 1042 and a third subpixel 1043; and step S102, forming at least one prism structure 106 on a light incident side of the pixel unit 104 by an imprinting process or a patterning process. The prism structure 106 can be configured such that after passing through the prism structure 106, the incident light 200 is at least split into light of a first waveband 201 incident on the first subpixel 1041, light of a second waveband 202 incident on the second subpixel 1042 and light of a third waveband 203 incident on the third subpixel 1043. Besides, the first waveband 201, the second waveband 202 and the third waveband 203 are different from each other.

It should be noted that the patterning process in step S102 can refer to a photolithography process. Specifically, the photolithography process can be a process for forming patterns by using photoresist, a mask plate or an exposure machine during processes such as film-forming, exposing and developing.

Besides, if the prism structure 106 is arranged exemplarily on the light incident side of the lower polarizer 107, specifically, at least one prism structure 106 can be formed on the light incident side of the pixel unit 104 by an imprinting process or a patterning process in the follow procedure.

For instance, firstly, a display module 01 provided with a lower polarizer 107 is placed in an imprinting device or a patterning device, and then a prism structure 106 is formed on a light incident side of the lower polarizer 107 by an imprinting process or a patterning process.

In another instance, it is also possible to first form a prism structure 106 on a flexible base substrate by an imprinting process or a patterning process, and then attach the flexible base substrate on which the prism structure 106 has been formed to a light incident side of a lower polarizer 107.

It should be noted that the prism structure 106 is arranged exemplarily on the light incident side of the lower polarizer 107. If the prism structure 106 is arranged at other positions in the display module 01, the manufacturing method of the prism structure 106 will be the same, which will not be repeated here for simplicity.

The manufacturing method of the display module is a method for manufacturing the display module provided in any of the above embodiments. Since beneficial effects of the display module have been described in detail in the above embodiments, beneficial effects of the manufacturing method will not be repeated here for simplicity.

What the above describes are only specific embodiments of this disclosure, but the protection scope of this disclosure is not limited thereto. Any variation or substitution easily conceivable for a skilled person familiar with this art within the technical scope of this disclosure shall fall within the protection scope of this disclosure. Therefore, the protection scope of this disclosure should be subject to the protection scope of the claims below.

1. A display module, comprising:
a pixel unit having a first subpixel, a second subpixel and a third subpixel; and
at least one prism structure arranged on a light incident side of the pixel unit, wherein after incident light passes through the prism structure, the incident light is at least split into light of a first waveband incident on the first subpixel, light of a second waveband incident on the second subpixel, and light of a third waveband incident on the third subpixel,
wherein the first waveband, the second waveband and the third waveband are different from each other.

2. The display module according to claim 1, further comprising:
a color filter unit arranged on a light exit side of the prism structure,
wherein the color filter unit comprises a first subunit, a second subunit, and a third subunit,
wherein the first subunit corresponds to the first subpixel, the second subunit corresponds to the second subpixel and the third subunit corresponds to the third subpixel.

3. The display module according to claim 1, wherein
the pixel unit further comprises a fourth subpixel,
wherein after incident light passes through the prism structure, the incident light is split into light of a first waveband, light of a second waveband, light of a third waveband and light of a fourth waveband, the light of the fourth waveband being incident on the fourth subpixel, and
the light of the first waveband is red light, the light of the second waveband is green light, the light of the third waveband is blue light, and the light of the fourth waveband is any one of yellow light, cyan light and magenta light.

4. The display module according to claim 1, wherein
the prism structure is a triangular prism structure,
a refractive index of the prism structure matches with that of an array substrate on which the pixel unit is arranged,
an angle is enclosed between a first side surface at the light incident side of the prism structure and an incident direction of the incident light, the first side surface being a curved surface protruding away from the pixel unit; and
a second side surface at the light exit side of the prism structure is a planar surface in parallel to the array substrate.

5. The display module according to claim 1, wherein
the prism structure is a triangular prism structure,
a first side surface at the light incident side of the prism structure is a planar surface,
an angle is enclosed between the first side surface and an incident direction of the incident light; and
a second side surface at the light exit side of the prism structure is a curved surface protruding towards the pixel unit.

6. The display module according to claim 4, wherein a radius of curvature of the curved surface is 100 μm-800 μm.

7. The display module according to claim 4, wherein the angle enclosed between the first side surface and the incident direction of the incident light crosses over the first side surface and gradually increases from 15° to 75°.

8. The display module according to claim 5, wherein the angle enclosed between the first side surface and the incident direction of the incident light falls within a range of 15°-75°.

9. The display module according to claim 1, wherein the prism structure comprises a plurality of strip-shaped prism structures, each strip-shaped prism structure corresponding to a column of pixel units in position.

10. The display module according to claim 1, wherein the prism structure comprises a plurality of block-shaped prism structures, each block-shaped prism structure corresponding to a pixel unit in position.

11. The display module according to claim 1, wherein
the display module comprises a lower polarizer, and
the prism structure is arranged on a light incident side of the lower polarizer.

12. A display device, comprising:
the display module according to claim 1; and
a backlight source for emitting parallel light.

13. A manufacturing method of a display module, comprising:
forming a pixel unit on a base substrate, the pixel unit at least comprising a first subpixel, a second subpixel and a third subpixel; and
forming at least one prism structure on a light incident side of the pixel unit by an imprinting process or a patterning process, the prism structure being configured such that after passing through the prism structure, incident light is at least split into light of a first waveband incident on the first subpixel, light of a second waveband incident on the second subpixel and light of a third waveband incident on the third subpixel, wherein
the first waveband, the second waveband and the third waveband are different from each other.

14. The display device according to claim 12, wherein the display module further comprises:
a color filter unit arranged on a light exit side of the prism structure, the color filter unit at least comprising a first subunit, a second subunit and a third subunit, wherein
the first subunit corresponds to the first subpixel, the second subunit corresponds to the second subpixel and the third subunit corresponds to the third subpixel.

15. The display device according to claim 12, wherein
the pixel unit further comprises a fourth subpixel,
after incident light passes through the prism structure, the incident light is split into light of a first waveband, light of a second waveband, light of a third waveband and light of a fourth waveband, the light of the fourth waveband being incident on the fourth subpixel, and
the light of the first waveband is red light, the light of the second waveband is green light, the light of the third waveband is blue light, and the light of the fourth waveband is any one of yellow light, cyan light and magenta light.

16. The display device according to claim 12, wherein
the prism structure is a triangular prism structure,
a refractive index of the prism structure matches with that of an array substrate on which the pixel unit is arranged,
an angle is enclosed between a first side surface at the light incident side of the prism structure and an incident direction of the incident light, the first side surface being a curved surface protruding away from the pixel unit; and
a second side surface at the light exit side of the prism structure is a planar surface in parallel to the array substrate.

17. The display device according to claim 12, wherein
the prism structure is a triangular prism structure,
a first side surface at the light incident side of the prism structure is a planar surface,
an angle is enclosed between the first side surface and an incident direction of the incident light; and
a second side surface at the light exit side of the prism structure is a curved surface protruding towards the pixel unit.

18. The display device according to claim 12, wherein the prism structure comprises a plurality of strip-shaped prism structures, each strip-shaped prism structure corresponding to a column of pixel units in position.

19. The display device according to claim 12, wherein the prism structure comprises a plurality of block-shaped prism structures, each block-shaped prism structure corresponding to a pixel unit in position.

20. The display device according to claim 12, wherein
the display module comprises a lower polarizer, and
the prism structure is arranged on a light incident side of the lower polarizer.
